(19) United States
(12) Patent Application Publication
(10) Pub. No.: US 2026/0148142 A1
(43) Pub. Date: May 28, 2026

(54) SYNTHETIC DATASET VALIDATION METHOD FOR TRAINING ARTIFICIAL INTELLIGENCE MODEL AND HARDWARE APPARATUS

(71) Applicant: Cubig Corp., Seoul (KR)

(72) Inventors: Min Chan CHUNG, Seoul (KR); Heon Seok HA, Seoul (KR)

(21) Appl. No.: 19/400,665

(22) Filed: Nov. 25, 2025

(30) Foreign Application Priority Data
Nov. 28, 2024 (KR) 10-2024-0174041

(51) Int. Cl. G06N 20/00

(52) U.S. Cl. CPC G06N 20/00

(57) ABSTRACT

A method by a hardware apparatus for validating a synthetic dataset for training an artificial intelligence model. The method may include: receiving, by a data processing apparatus, an original dataset; generating, by the data processing apparatus, a plurality of synthetic data items based on at least a portion of the original data in the original dataset; determining, by the data processing apparatus, a validation threshold according to at least one validation metric based on requirements for synthetic data; validating, by the data processing apparatus, each of the plurality of synthetic data items using the at least one validation metric; and comparing, by the data processing apparatus, validation results of the plurality of synthetic data items based on the validation threshold to determine valid synthetic data among the plurality of synthetic data items as a final synthetic dataset.

### CROSS REFERENCE TO RELATED APPLICATION

This application claims priority to and the benefit of Korean Patent Application No. 10-2024-0174041, filed Nov. 28, 2024, the entire contents of which are incorporated herein by reference.

### BACKGROUND

### Technical Field

The present disclosure relates to a validation technique for synthetic data used in constructing an artificial intelligence model.

### Description of the Related Art

Artificial intelligence has been attracting attention as a technology for extracting and analyzing valuable information from structured or unstructured data in various fields. Generally, artificial intelligence requires a large amount of training data during the learning process. Training data may include personal information or sensitive information. Various de-identification techniques have been proposed to protect personal information. However, most de-identification techniques suffer from loss of information from the original data during the personal information protection process, making it difficult to obtain excellent results.

To solve such problems, synthetic data generation techniques have been proposed. Synthetic data consists of data that has similar characteristics to actual data but is not directly related to personal information. Therefore, synthetic data does not require personal information protection measures and can be used for various analyses and research.

The description of the related art should not be assumed to be prior art merely because it is mentioned in or associated with this section. The description of the related art includes information that describes one or more aspects of the subject technology, and the description in this section does not limit the invention.

### SUMMARY

In one or more aspects of the present disclosure, a method for validating a synthetic dataset for training an artificial intelligence model includes: receiving, by a data processing apparatus, an original dataset; generating, by the data processing apparatus, a plurality of synthetic data items based on at least some of original data in the original dataset; determining, by the data processing apparatus, a validation threshold according to at least one validation metric based on requirements for synthetic data; validating, by the data processing apparatus, each of the plurality of synthetic data items using the at least one validation metric; and comparing, by the data processing apparatus, validation results of the plurality of synthetic data items based on the validation threshold to determine valid synthetic data among the plurality of synthetic data items as a final synthetic dataset, wherein the final synthetic dataset is utilized as training data for constructing an artificial intelligence model.

In one or more aspects of the present disclosure, a hardware apparatus for constructing a synthetic dataset includes: an input device configured to receive an original dataset; and a processor configured to generate a plurality of synthetic data items based on at least some of original data in the original dataset, validate each of the plurality of synthetic data items using at least one validation metric, compare validation results of the plurality of synthetic data items based on a validation threshold, and determine valid synthetic data among the plurality of synthetic data items as a final synthetic dataset, wherein the validation threshold is determined based on the at least one validation metric according to requirements for synthetic data using the original dataset, and wherein the final synthetic dataset is used as training data for constructing an artificial intelligence model.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 illustrates an example of a system for providing synthetic data.

FIG. 2 illustrates an example of a process for validating synthetic data.

FIG. 3 illustrates an example of a process for determining a threshold for synthetic data validation.

FIG. 4 illustrates an example of a hardware apparatus.

Throughout the drawings and the detailed description, unless otherwise described, the same drawing reference numerals should be understood to refer to the same elements, features, and structures. The sizes of regions and elements, and depiction thereof may be exaggerated for clarity, illustration, and/or convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be understood by those of ordinary skill in the art.

Moreover, descriptions of well-known functions and constructions may be omitted for increased clarity and conciseness. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, locations, and areas), proportions, ratios, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., components, structures, groups, circuits, networks, members, parts, areas, portions, integers, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., components, structures, groups, circuits, networks, members, parts, areas, portions, and/or the like) are described using any of the terms such as “adjacent to,” “beside,” “next to,” and/or the like indicating a position or location, one or more other elements may be located between the two elements unless a more limiting term, such as “immediate(ly),” “direct(ly),” or “close(ly),” is used. Furthermore, the spatially relative terms such as the foregoing terms as well as other terms such as “column,” “row,” “vertical,” “horizontal,” “diagonal,” and the like refer to an arbitrary frame of reference.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., components, structures, groups, circuits, networks, members, parts, areas, portions, and/or the like), these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., component, structure, group, circuit, network, member, part, area, portion, and/or the like) “is engaged” with another element may be understood, for example, as that the element may be either directly or indirectly engaged with the another element. The term “is engaged” or similar expressions may refer to a term such as “is connected,” “is coupled,” “is combined,” “is linked,” “is provided,” “interacts,” or the like. The engagement may involve one or more intervening elements disposed or interposed between the element and the another element, unless otherwise specified.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) multiple elements of the plurality of elements, or (v) all of the plurality of elements. Moreover, “at least some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, or (iii) the element, or all portions of the element.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” may indicate a degree of being considered as being equivalent to each other taking into account minute differences due to errors in the manufacturing or operating process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for the convenience of description, a scale and dimension of each of the elements illustrated in the accompanying drawings may be different from an actual scale and dimension, and thus, embodiments of the present disclosure are not limited to a scale and dimension illustrated in the drawings.

Before starting detailed explanations of figures, components that will be described in the specification are distinguished merely according to functions mainly performed by the components. That is, two or more components which will be described later can be integrated into a single component. Furthermore, a single component which will be explained later can be separated into two or more components. Moreover, each component which will be described can additionally perform some or all of a function executed by another component in addition to the main function thereof. Some or all of the main function of each component which will be explained can be carried out by another component. Accordingly, presence/absence of each component which will be described throughout the specification should be functionally interpreted.

The description below relates to a synthetic data validation technique.

The terms used in the following description are defined as follows.

Original Data refers to initial data that serves as a basis for generating synthetic data. Original data may include sensitive personal information.

Personal Information means information that can identify an individual through name, resident registration number, image, etc. Personal information may include unique identification information such as resident registration number, passport number, driver's license number, and foreigner registration number. Sensitive Information means information about thoughts, beliefs, membership/withdrawal of labor unions or political parties, political views, health, sex life, etc., and other information that may significantly infringe on the privacy of the data subject. Hereinafter, personal information is used in a broad sense including sensitive information.

Original Dataset is a collection of a plurality of original data items. An original dataset may be divided into a subset used for generating synthetic data and a subset for performance evaluation of synthetic data. In particular, a dataset for performance evaluation of synthetic data among the original dataset is referred to as an original validation dataset.

Synthetic Data means data generated for constructing an artificial intelligence model. Synthetic data can be constructed through various methodologies. Hereinafter, it is assumed that synthetic data is generated using a generative model that generates virtual data based on original data. A generative model means a neural network model that generates synthetic data without exposing personal information from input data.

However, the synthetic data validation technique described below is not limited to a specific methodology for generating synthetic data.

Synthetic Dataset is a collection of a plurality of synthetic data items.

Original data or synthetic data may be any one of various types (modalities) of data. For example, the data modality may be various types such as images, text, and sound. Hereinafter, the type of data is not limited. That is, the technology described below is applicable to generation and validation of various types of training data.

Hereinafter, it is described that a data processing apparatus validates synthetic data. Meanwhile, the data processing apparatus may also perform synthetic data generation. A data processing apparatus means a computer device capable of data preprocessing, data processing, and driving a generative model. The data processing apparatus may be implemented in the form of a server, PC, smart device, or chip with embedded programs.

Validation of Synthetic Data corresponds to a process of evaluating usefulness and/or safety aspects. Usefulness means whether synthetic data is effective for training an artificial intelligence model. Usefulness can be evaluated based on the similarity between training data and original data. Synthetic data with high usefulness can contribute to constructing an artificial intelligence model with high performance. Safety is an item that evaluates the risk of exposing information of original data through synthetic data. That is, safety is an item that evaluates whether there is a concern of exposing sensitive personal information when replacing original data with synthetic data.

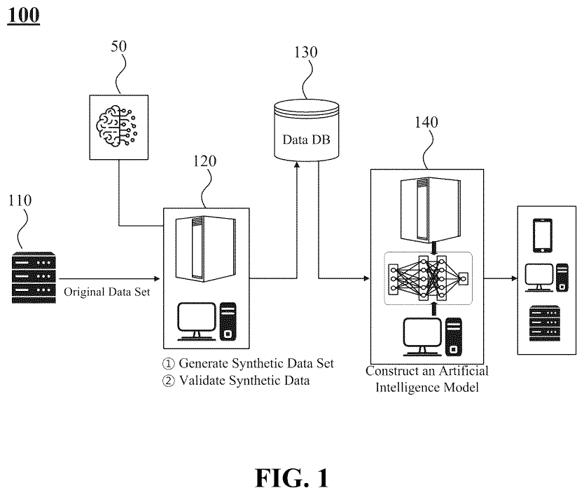

FIG. 1 illustrates an example of a system 100 for providing synthetic data.

An information collection device 110 is a device that collects or stores original data. For example, the information collection device 110 may be a server managed by a medical institution, an Internet service company, a telecommunications company, or a financial institution. Original data may include personal information.

Alternatively, the information collection device 110 may store various types of data collected from individuals. The information collection device 110 may store a single original data or a single original dataset.

A data processing apparatus 120 receives an original dataset. The data processing apparatus 120 may receive an original dataset from the information collection device 110. In FIG. 1, the data processing apparatus 120 is illustrated as a device such as a PC or a server.

The data processing apparatus 120 may generate a certain synthetic dataset based on the original dataset.

The data processing apparatus 120 may generate synthetic data using any one of various algorithms or various learning models. The data processing apparatus 120 may generate synthetic data using a model built-in itself. In this case, the data processing apparatus 120 may generate synthetic data from which personal information included in the original data has been removed.

Alternatively, the data processing apparatus 120 may generate synthetic data using an external deep learning server 50. The data processing apparatus 120 may transmit certain original data or a part of the original data as input data to the deep learning server 50 and receive synthetic data generated by the deep learning server 50. In this process, the data processing apparatus 120 may transmit original data excluding personal information or with personal information replaced with other information to the deep learning server 50 without exposing the personal information of the original data.

The deep learning server 50 may generate certain synthetic data based on input data using a generative model. Alternatively, the deep learning server 50 may synthesize images or sentences based on input data using a Large Language Model (LLM). In this case, the synthetic data generated by the deep learning server 50 may be data from which personal information of the original data has been removed.

The data processing apparatus 120 generates its own synthetic dataset or cooperates with the deep learning server 50 to generate a synthetic dataset.

The data processing apparatus 120 holds an original dataset and a synthetic dataset. The data processing apparatus 120 may validate synthetic data included in the synthetic dataset. Here, validation is a process of evaluating the usefulness and safety of synthetic data as described above. The data processing apparatus 120 may remove data that does not meet certain criteria based on usefulness and/or safety from among the synthetic data from the synthetic dataset. The data processing apparatus 120 may determine a validation threshold for synthetic data validation using at least a part of the original dataset. The data processing apparatus 120 may evaluate the performance of synthetic data based on the validation threshold. A specific synthetic data validation and removal process will be described later.

The data processing apparatus 120 may construct a final synthetic dataset with validation data that meets the validation criteria. The data processing apparatus 120 may store the final synthetic dataset in a separate data database (DB) 130.

The data processing apparatus 120 may transmit the synthetic dataset to a training device 140. Alternatively, the training device 140 may extract the synthetic dataset from the data DB 130. The training device 140 means a computing device that constructs a certain artificial intelligence model.

The training device 140 may construct (train) a certain artificial intelligence model using the received synthetic dataset. The training device 140 may transmit the constructed artificial intelligence model to other objects. For example, a user terminal or a service server may perform certain inference using the constructed artificial intelligence model and provide data or information according to the inference result to the user.

### Synthetic Data Validation Process

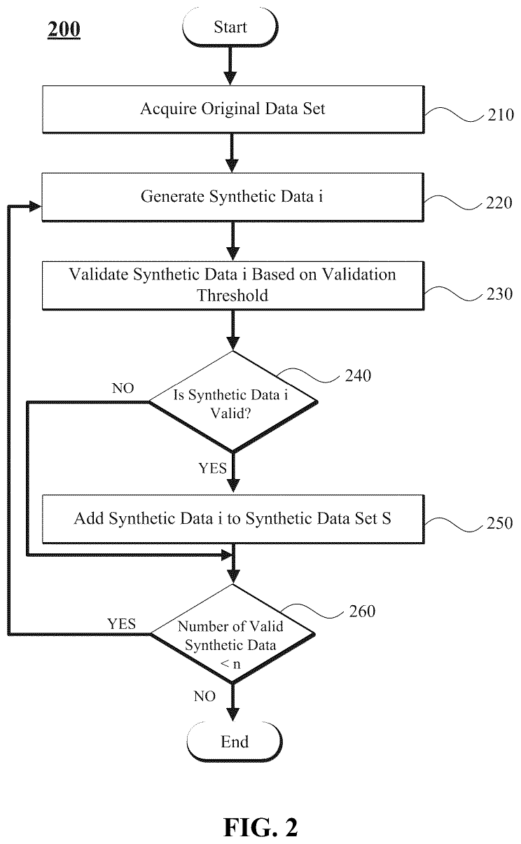

FIG. 2 illustrates an example of a process 200 for validating synthetic data.

The data processing apparatus acquires an original dataset (210).

The data processing apparatus generates synthetic data. At this time, the data processing apparatus may select a specific generative model for generating synthetic data. The generative model may be any one of various types of models. For example, the generative model may be one of types of models such as Generative Adversarial Networks (GAN) and diffusion models. At this time, the generative model is a pre-trained model.

The data processing apparatus may generate certain synthetic data based on one original data (220). The data processing apparatus may generate synthetic data by inputting the original data into the generative model. The synthetic data generated at this time is referred to as synthetic data i.

At this time, synthetic data validation may use any one of various methodologies or a combination of various methodologies. Validation items of synthetic data include usefulness and safety as shown in Table 1 below. Validation of synthetic data may be evaluated based on at least one of usefulness and safety.

TABLE 1

| Usefulness | Safety |
|---|---|
| Evaluates how similar synthetic | Evaluates the risk of exposing original |
| data is to original data | data through synthetic data |
| Evaluates how much synthetic | Evaluates how safe sensitive |
| data can replace original data | information is when replacing original |
| | data with synthetic data |

The data validation method may differ depending on the data modality.

Examples of evaluation techniques or evaluation metrics (validation metrics) applicable regardless of data type are shown in Table 2 below.

TABLE 2

| Usefulness | Safety |
|---|---|
| Data distribution similarity | Structural similarity |
| Classification model performance | Perceptual similarity |
| Indistinguishability | |

Data Distribution Similarity is a technique that evaluates similarity by projecting the original dataset and the synthetic dataset into the same space and then comparing the statistical properties of the two distributions. Here, the space is a space defined based on the characteristics of the data. For example, the space may be an embedding space.

Classification Model Performance is a result of comparing the inference performance (e.g., classification accuracy) of learning models on validation data, which is a part of the original data, after constructing certain learning models using the original dataset and the synthetic dataset respectively.

Indistinguishability is evaluated by constructing a learning model using the original dataset and then measuring the inference performance of the learning model constructed using a validation dataset including the original dataset and the synthetic dataset. That is, indistinguishability can be evaluated as the similarity of inference results on the original dataset and the validation dataset.

Structural Similarity means the morphological similarity between individual samples of original data and synthetic data. For example, structural similarity can be evaluated with a metric such as Structural Similarity Index Measure (SSIM). If synthetic data is structurally excessively similar to original data, safety can be evaluated as low.

Perceptual Similarity means the similarity of original data and synthetic data interpreted by a neural network model. For example, perceptual similarity can be evaluated with a metric such as Learned Perceptual Image Patch Similarity (LPIPS). This metric represents the similarity between features of original data and features of synthetic data extracted from an encoder of a neural network model. If synthetic data is perceptually excessively similar to original data, safety can be evaluated as low.

### (1) Usefulness Evaluation

The data processing apparatus may evaluate the usefulness of synthetic data. The data processing apparatus may validate synthetic data based only on the usefulness of synthetic data.

At this time, the data processing apparatus may evaluate the usefulness of synthetic data based on a certain threshold (validation threshold). Different values may be used as validation thresholds according to evaluation methodologies.

The data processing apparatus may evaluate the usefulness of synthetic data based on the evaluation metrics described in Table 2. The data processing apparatus may evaluate the usefulness of synthetic data based on at least one of the evaluation metrics described in Table 2.

(i) If the data distribution similarity between synthetic data and original data (or between the original dataset and the synthetic dataset) is less than a certain threshold, the data processing apparatus may determine that the synthetic data or synthetic dataset is not valid. The certain threshold value for verification may use experimentally determined values.

(ii) The data processing apparatus may verify the performance of learning models constructed using the original dataset and the synthetic dataset respectively using validation data (a part of the original dataset). The data processing apparatus may evaluate the accuracy of inference results of a learning model (first model) constructed using the original dataset and a learning model (second model) constructed using the synthetic dataset. If the inference results of the first model and the inference results of the second model differ by more than a threshold (e.g., if the inference results differ more than 5 times out of 100 verification processes), the data processing apparatus may determine that the synthetic dataset is not valid. The threshold value for verification may use experimentally determined values.

(iii) The data processing apparatus may construct a learning model using the original dataset and then evaluate the inference accuracy of the learning model constructed using a validation dataset including the original dataset and the synthetic dataset. For example, if the verification results of the learning model differ by more than a threshold (e.g., if the inference results differ more than 5 times out of 100 verification processes), the data processing apparatus may determine that the synthetic dataset is not valid. The threshold value for verification may use experimentally determined values.

### (2) Safety Evaluation

In addition, the data processing apparatus may evaluate the safety of synthetic data. The data processing apparatus may validate synthetic data based only on the safety of synthetic data.

At this time, the data processing apparatus may evaluate the safety of synthetic data based on a certain threshold (validation threshold). Different values may be used as validation thresholds according to evaluation methodologies.

The data processing apparatus may evaluate the usefulness of synthetic data based on the evaluation metrics described in Table 2. The data processing apparatus may evaluate the usefulness of synthetic data based on at least one of the evaluation metrics described in Table 2.

(i) If the structural similarity between synthetic data and original data exceeds first threshold, the data processing apparatus may determine that the synthetic data is not valid.

(ii) If the perceptual similarity between synthetic data and original data exceeds second threshold, the data processing apparatus may determine that the synthetic data is not valid.

The first threshold value and second threshold value for verification may each use experimentally determined values.

### (3) Combined Evaluation

In addition, the data processing apparatus may evaluate both usefulness and safety of synthetic data. In this case, the data processing apparatus may evaluate the synthetic data (or synthetic dataset) as valid when both the usefulness and safety of the synthetic data meet the criteria. Usefulness evaluation and safety evaluation criteria or methods are as described above.

In evaluating the usefulness and safety of synthetic data, there are criteria (thresholds) for evaluating the validity of synthetic data for each methodology. Therefore, the data processing apparatus must first determine the validation threshold(s). The data processing apparatus may determine validation thresholds for each of the methodologies or items for evaluating usefulness and safety.

The data processing apparatus may determine a threshold for validation (validation threshold) based on the original dataset and may validate synthetic data i based on the validation threshold (230). A specific process for determining the validation threshold will be described later.

The data processing apparatus checks whether synthetic data i is valid according to the validation result (240). For example, the data processing apparatus may validate the usefulness and/or safety item(s) of synthetic data i based on each validation threshold. The validation process or criteria are as described above.

If synthetic data i is valid (YES in 240), the data processing apparatus adds synthetic data i to synthetic dataset S (250).

Assume that the data processing apparatus aims to generate a synthetic dataset composed of n synthetic data. If the number of currently valid synthetic data is less than n (YES in 260), the data processing apparatus generates new synthetic data and performs validation in the same process.

If the number of currently valid synthetic data is n, the data processing apparatus terminates the process of constructing the synthetic dataset (NO in 260).

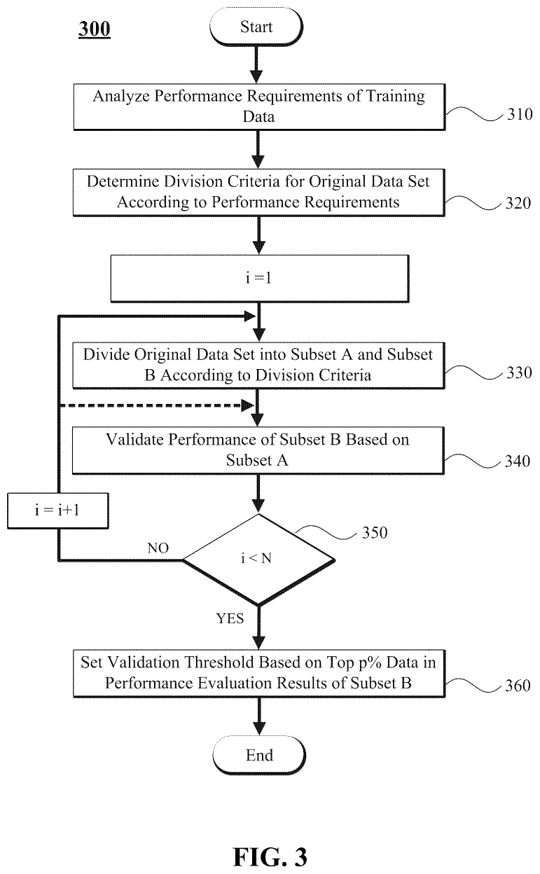

FIG. 3 illustrates an example of a process 300 for determining a threshold for synthetic data validation. FIG. 3 illustrates an example of a process for determining criteria or thresholds for evaluating the performance (usefulness and/or safety) of synthetic data. Validation thresholds may be individually determined according to validation items and validation techniques as described above. Hereinafter, a process of determining a validation threshold for a specific validation technique belonging to any one validation item will be described. At this time, the specific validation technique may be any one of the validation techniques in Table 2.

The data processing apparatus may determine a validation threshold using the original dataset.

It is assumed that the data processing apparatus has acquired an original dataset.

The data processing apparatus analyzes the performance requirements of training data (310). Performance requirements of training data are performance requirements required for training data for constructing a specific learning model. Performance requirements may be at least one of usefulness and safety items. Furthermore, the performance requirements may include specific validation technique(s) for usefulness and/or safety items. At this time, the validation technique may include at least one of the validation techniques in Table 2. Performance requirements are information determined in advance according to the learning model and application to be constructed with training data.

The data processing apparatus may determine criteria for dividing the original dataset according to the performance requirements of training data (320).

For example, if usefulness is the highest priority performance requirement, the data processing apparatus may determine the distribution of original data belonging to the original dataset as a division criterion. Alternatively, if safety is the highest priority performance requirement, the data processing apparatus may determine the structural similarity and/or perceptual similarity of original data belonging to the original dataset as a division criterion.

The data processing apparatus may divide the original dataset into subset A and subset B according to the division criterion based on the performance requirements. The data processing apparatus may repeat the performance evaluation process using subset A and subset B N times. Setting i=1, the data processing apparatus may repeat the evaluation process until i=N.

The data processing apparatus divides the original dataset into subset A and subset B according to the division criterion based on the performance requirements (330).

Alternatively, in some cases, the data processing apparatus may randomly divide the original dataset to generate subset A and subset B.

The data processing apparatus assumes subset A as the original dataset and subset B as the synthetic dataset. The data processing apparatus may evaluate the performance of subset B based on subset A (340). At this time, the performance evaluation metric may be any one of the techniques in Table 2.

The data processing apparatus repeats the performance evaluation process for subset B N times. If i<N (NO in 350), the data processing apparatus may repeat the process of re-dividing the original dataset according to the division criterion and evaluating performance. Alternatively, if i<N (NO in 350), the data processing apparatus may repeat the process of evaluating the performance of subset B based on the divided subset A.

If i=N (YES in 350), the data processing apparatus terminates the performance evaluation process using subsets. The data processing apparatus sets the validation threshold based on the top data (p %) with high performance among the data belonging to subset B from the results of evaluating the performance of subset B. p is a natural number or a positive real number.

For example, if the performance evaluation metric is data distribution similarity, the data processing apparatus may determine the validation threshold as the average similarity of the top p % of data with high performance among the data belonging to subset B. Where p is a positive real number ≤100. Alternatively, the data processing apparatus may determine the validation threshold as the similarity of data corresponding to the p % point in the order of high performance among the data belonging to subset B. The data processing apparatus may determine the validation threshold as the similarity of data corresponding to a certain rank in the order of high performance among the data belonging to subset B. Furthermore, for classification model performance, indistinguishability, structural similarity, and perceptual similarity, the data processing apparatus may determine validation thresholds in a similar manner.

Furthermore, the data processing apparatus may divide the original dataset in various ways according to performance requirements. If performance items or evaluation techniques of performance requirements are diverse, division criteria may be different from each other. In such a case, the data processing apparatus may determine validation thresholds by dividing the original dataset with different division criteria according to performance requirements. That is, the data processing apparatus may determine validation thresholds for each of various performance items or evaluation metrics according to the method of FIG. 3.

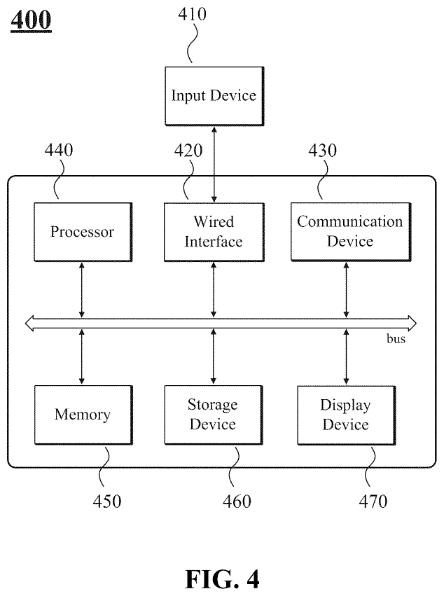

FIG. 4 illustrates an example of a hardware apparatus 400. The hardware apparatus 400 corresponds to the data processing apparatus described above. The hardware apparatus 400 may have the form of a computer device, a smart device, a server in a network, or a chipset dedicated to data processing.

The hardware apparatus 400 may include an input device 410, a wired interface 420, a communication device 430, a processor 440, a memory 450, and a storage device 460.

Alternatively, the hardware apparatus 400 may include an input device 410, a wired interface 420, a communication device 430, a processor 440, a memory 450, a storage device 460, and a display device 470.

Each internal component of the hardware apparatus 400 may be connected by a bus. A specific bus may be used depending on the type of entity being connected. For example, the bus may be any one of AMBA (AHB/AXI/APB), PCIe, SPI (Serial Peripheral Interface), or MIPI (Mobile Industry Processor Interface).

The input device 410 is a device that receives user commands or information.

In addition, the input device 410 may be a device that receives necessary data from an externally connected device or storage device.

The input device 410 may receive an original dataset from a user.

The input device 410 may receive an original dataset from a physically connected device or external storage device.

The input device 410 may be any one of various types of devices. For example, the input device 410 may be at least one of a mouse, a keyboard, a touch input device, a camera, a Small Computer System Interface (SCSI) device, a Peripheral Component Interconnect (PCI) bus-based device, or an ATA Packet Interface (ATAPI) device.

The wired interface 420 is a device component that transmits data transmitted by the input device 410 to the inside of the device. The wired interface 420 may be composed of software drivers and hardware.

The wired interface 420 may include a controller corresponding to each input device, a device driver that controls the operation of the controller, and a kernel I/O subsystem that comprehensively manages input/output control requests of the device driver. The kernel I/O subsystem stores input/output requests from device drivers in a queue and schedules the requests based on request priority or device status.

The wired interface 420 may include interfaces such as PS/2, Universal Serial Bus (USB), Ethernet port, HDMI, MIPI CSI, DisplayPort, and Thunderbolt.

The wired interface 420 may transmit the final synthetic dataset to other components inside the device or external objects.

The communication device 430 means a component that receives and transmits certain information through an external wired or wireless network. The communication device 430 may be composed of a circuit including an antenna and a communication module (S/W module, chip, etc.) corresponding to a communication protocol. The communication protocol may be at least one of wired LAN (Ethernet), wireless LAN (IEEE 802.11), mobile communication (LTE, 5G NR, etc.), Bluetooth, and NFC.

The communication device 430 may receive an original dataset from an external object.

The communication device 430 may transmit de-identified data which personal information has been removed from the original data to an external deep learning server. In addition, the communication device 430 may receive synthetic data from the deep learning server.

The communication device 430 may transmit the final synthetic dataset to external objects such as a training device or data DB.

The processor 440 controls the operation of all components of the hardware apparatus 400. In addition, the processor 440 controls the visualization process of simulation data.

The processor 440 may perform operations on at least one application or computer program for executing methods/operations according to various embodiments of the present disclosure.

The processor 440 is a general-purpose processor that executes at least a part of a control program installed in the storage device 460 or at least a part of a program loaded in the memory 450.

The processor 440 may be implemented as circuitry (e.g., processing circuitry) such as a system on chip (SoC) or an integrated circuit (IC).

The processor 440 may include one or more processors. For example, the processor 440 may include a combination of one or more processors such as a central processing unit (CPU), microprocessor unit (MPU), micro controller unit (MCU), graphic processing unit (GPU), neural processing unit (NPU), digital signal processor (DSP), application processor (AP), communication processor (CP), or any form of processor well known in the technical field of the present disclosure.

The memory 450 may store data and information generated in the process of validating synthetic data. The memory 450 is a volatile memory such as DRAM or SRAM.

The storage device 460 may store control programs, visualization tools, metadata of simulation data, rendered data, sorted frames, etc.

The storage device 460 may be implemented as a device such as a hard disk drive, Solid State Drive, USB flash drive, memory card, optical disk, or network-based storage device (Network Attached Storage, cloud storage, etc.).

The storage device 460 may store an original dataset.

The storage device 460 may store programs or generative models that generate synthetic data.

The storage device 460 may store learning models, neural network models, etc. for synthetic data validation. For example, classification model performance and indistinguishability verification require building models for verification.

The storage device 460 may store an initial synthetic dataset generated from the original dataset.

The storage device 460 may store a synthetic dataset composed of finally valid synthetic data.

The storage device 460 may store source code or programs that control synthetic data generation and validation processes.

The display device 470 may output interfaces necessary for the filtering process, original dataset information, final training dataset information, etc.

The display device 470 may be implemented as various types of devices.

The display device 470 may be implemented with various display methods such as liquid crystal, plasma, light-emitting diode, organic light-emitting diode, surface-conduction electron-emitter, carbon nano-tube, and nano-crystal.

The processor 440 may generate synthetic data using original data.

The processor 440 may generate a plurality of synthetic data items using a plurality of original data items belonging to the original dataset.

Various methodologies or generative models may be used for synthetic data generation.

The processor 440 may determine a threshold (validation threshold) for the validation process according to validation items and evaluation metrics. When using a plurality of validation items and/or a plurality of validation metrics, the processor 440 may determine validation thresholds for each item and evaluation metric.

The validation threshold setting process is as described in FIG. 3. The processor 440 may determine division criteria according to training data requirements. Division criteria may differ according to validation items and evaluation metrics.

The processor 440 divides the original dataset into subset A and subset B according to the division criteria. The processor 440 may verify the performance of subset B (assumed to be a synthetic dataset) based on subset A (assumed to be an original dataset). The processor 440 may repeat the performance verification process for subset B. In addition, the processor 440 may determine validation thresholds using subset A and subset B for each validation item and evaluation metric.

The processor 440 may validate each of the generated synthetic data based on the validation threshold determined for a specific validation item and evaluation metric.

Depending on the validation technique (classification model performance verification or indistinguishability verification), the processor 440 must build a model for verification using the synthetic dataset and/or the original dataset.

The processor 440 may configure a final synthetic dataset with only valid synthetic data that meets the criteria according to performance verification results. Individual verification processes are as described in FIG. 2, etc.

The non-transitory computer readable medium refers to a medium that stores data semi-permanently (e.g., the storage device) and is capable of being read by a device, rather than a medium that stores data for a short period of time, such as a register, cache, or memory. Specifically, the various applications or programs described above may be provided by being stored in the non-transitory computer readable medium such as a CD, a DVD, a hard disk, a Blu-ray disk, a USB, a memory card, a read-only memory (ROM), a programmable read only memory (PROM), an erasable PROM (EPROM), an electrically EPROM (EEPROM), or a flash memory.

The transitory computer readable medium refers to various types of RAM such as a static RAM (SRAM), a dynamic RAM (DRAM), a synchronous DRAM (SDRAM), a double data rate SDRAM (DDR SDRAM), an enhanced SDRAM (ESDRAM), a synclink DRAM (SLDRAM), and a direct Rambus RAM (DRRAM).

Various examples and aspects of the present disclosure are described below. These are provided as examples, and do not limit the scope of the present disclosure.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide examples of the technical features of the present disclosure for illustrative purposes. In other words, the disclosed embodiments are intended to illustrate the scope of the technical features of the present disclosure. Thus, the scope of the present disclosure is not limited to the embodiments shown, but is to be accorded the widest scope consistent with the claims. The scope of protection of the present disclosure should be construed based on the following claims, and all technical features within the scope of equivalents thereof should be construed as being included within the scope of the present disclosure.

What is claimed is:

1. A method for validating a synthetic dataset for constructing an artificial intelligence model, the method comprising:
receiving, by a data processing apparatus, an original dataset;
generating, by the data processing apparatus, a plurality of synthetic data items based on at least a portion of the original data in the original dataset;
determining, by the data processing apparatus, a validation threshold according to at least one validation metric based on requirements for synthetic data;
validating, by the data processing apparatus, each of the plurality of synthetic data items using the at least one validation metric; and
selecting, by the data processing apparatus, from validation results of the plurality of synthetic data items, those that satisfy the validation threshold to constitute a final synthetic dataset,
wherein the final synthetic dataset is used as training data for constructing an artificial intelligence model.

2. The method of claim 1, wherein the data processing apparatus generates the plurality of synthetic data items based on the at least a portion of the original data using a generative model.

3. The method of claim 1, wherein the determining the validation threshold comprises:
dividing, by the data processing apparatus, the original dataset into a first subset and a second subset;
validating, by the data processing apparatus, performance of the second subset based on the first subset using the at least one validation metric; and
determining, by the data processing apparatus, the validation threshold based on a performance score of data items within a top p percent among the second subset where p is a positive real number.

4. The method of claim 3, wherein the data processing apparatus divides the first subset and the second subset according to a division criterion based on the requirements of the synthetic data.

5. The method of claim 1, wherein the at least one validation metric is at least one of a usefulness validation metric and a safety validation metric.

6. The method of claim 5, wherein:
the usefulness validation metric comprises at least one of data distribution similarity, classification model performance, and indistinguishability; and
the safety validation metric comprises at least one of structural similarity and perceptual similarity.

7. A hardware apparatus for constructing a synthetic dataset, the hardware apparatus comprising:
an input device configured to receive an original dataset; and
a processor configured to:
generate a plurality of synthetic data items based on at least a portion of the original data in the original dataset,
validate each of the plurality of synthetic data items using at least one validation metric,
compare validation results of the plurality of synthetic data items with a validation threshold, and
select valid synthetic data among the plurality of synthetic data items as a final synthetic dataset,
wherein the validation threshold is determined from the original dataset based on the at least one validation metric in view of synthetic data requirements, and
wherein the final synthetic dataset is used as training data for constructing an artificial intelligence model.

8. The hardware apparatus of claim 7, wherein the processor generates the plurality of synthetic data items based on the at least a portion of original data using a generative model.

9. The hardware apparatus of claim 7, wherein the processor:
divides the original dataset into a first subset and a second subset,
validates performance of the second subset based on the first subset using the at least one validation metric, and
determines the validation threshold based on a validation result of data within a top p % performance range among data items belonging to the second subset.

10. The hardware apparatus of claim 9, wherein the processor divides the first subset and the second subset according to a division criterion based on the requirements of the synthetic data.

11. The hardware apparatus of claim 7, wherein the at least one validation metric is at least one of a usefulness validation metric and a safety validation metric.

12. The hardware apparatus of claim 11, wherein:
the usefulness validation metric comprises at least one of data distribution similarity, classification model performance, and indistinguishability; and
the safety validation metric comprises at least one of structural similarity and perceptual similarity.
